(19) United States
(12) Patent Application Publication
(10) Pub. No.: US 2008/0309926 A1
(43) Pub. Date: Dec. 18, 2008

(54) SYSTEMS AND METHODS FOR REDUCING DETECTED INTENSITY NON UNIFORMITY IN A LASER BEAM

(76) Inventors: Aaron Weber, Cambridge, MA (US); David H. Tracy, Norwalk, CT (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/043,077

(22) Filed: Mar. 5, 2008

Related U.S. Application Data
(63) Continuation-in-part of application No. 11/370,605, filed on Mar. 8, 2006, now Pat. No. 7,397,546.

(51) Int. Cl. G01J 1/00

(52) U.S. Cl. 356/121

(57) ABSTRACT

A method of increasing the spatial uniformity of the detected intensity of a beam of light from a laser in a system including the laser and a light detector. In one embodiment the method includes the steps of generating a beam of light with the laser; and moving the beam of light and the light detector relative to each other, such that the detector averages the spatial intensity of the beam of light over time. In another embodiment the invention relates to a system for increasing the detected spatial uniformity of the intensity of a beam of light. In one embodiment the system comprises a light detector; a laser source for generating the beam of light; and a means for moving the beam of light and the detector relative to one another such that the detector averages the intensity of the light beam over time.

### RELATED APPLICATIONS

This Application is a continuation-in-part of U.S. Ser. No. 11/370,605, filed on Mar. 8, 2006.

### FIELD OF THE INVENTION

The present invention relates to lasers, and specifically to improved methods for reducing detected intensity non-uniformity in a laser beam.

### BACKGROUND OF THE INVENTION

Many measurements require the use of a laser as a source of light. For example, lasers are used in systems ranging from simple object imaging to the detection of nucleotides in sequencing-by-synthesis reactions. In such systems various types of lasers are used, including gas lasers, chemical lasers, excimer lasers, solid-state lasers, semiconductor lasers (including diode lasers), dye lasers and hollow cathode sputtering metal ion lasers. Each type of laser has its own set of advantages and disadvantages when used for a specific application. For example, the characteristics of the different types of lasers including power output, wavelength, cost, size, tenability and uniformity of intensity over a cross-section of the beam are either advantages or disadvantages depending on the application in which the laser is used.

Diode lasers are low cost, have a relatively high power output and are small in size. A diode laser includes a radiating area or facet that has a very low aspect (height to width) ratio. That is, the height of the radiating facet is much smaller than its width. The beam produced by the laser diode facet is not uniform in intensity across the radiating facet. Because of the lack of uniformity in beam intensity, laser diodes diodes conventionally have been viewed as not appropriate for applications where beam intensity uniformity is required. Therefore, in applications in which high power and uniformity are required other lasers such as gas lasers, which are more expensive and quite large, are generally used.

In many applications, decreasing the cost and size of the laser greatly decreases overall equipment and hence research costs. Thus, a method or system to decrease the detected non-uniformity in the intensity of a diode laser beam could increase the efficiency and decrease the size of the equipment used in selected applications.

The present invention addresses the problem of detected beam intensity non-uniformity in a laser beam of light.

### SUMMARY OF THE INVENTION

This invention relates to systems and methods of reducing detected intensity non-uniformity of a laser diode beam so that laser diodes can be implemented in circumstances requiring a detection of a uniform beam of laser light.

In one aspect the invention relates to a method of increasing the spatial uniformity of the detected intensity of a beam of light from a laser in a system including the laser and a light detector. In one embodiment the method includes the steps of generating a beam of light with the laser; and moving the beam of light and the light detector relative to each other, such that the detector averages the spatial intensity of the beam of light over time. In another embodiment the step of moving the beam comprises the step of passing the beam of light into a two-dimensional retroreflector and moving a reflective wall of the retroreflector. In yet another embodiment the step of moving the beam comprises passing the beam into a rotating polygon, which may be a transparent polygon. In yet another embodiment, the step of moving the beam comprises physically moving the light source relative to the detector.

In another aspect the invention relates to a system for increasing the detected spatial uniformity of the intensity of a beam of light. In one embodiment, the system comprises a light detector, a laser source for generating the beam of light, and a means for moving the beam of light and the detector relative to one another such that the detector averages the intensity of the light beam over time. In another embodiment the, system includes a retroreflector, having a moving reflective wall, into which is passed the beam of light. In yet another embodiment the system includes a rotating transparent polygon through which is passed the beam of light.

In another aspect, the invention relates to a system for increasing the detected spatial uniformity of the intensity of a beam of light. In one embodiment, the system includes a light detector; a laser source for generating the beam of light; and a translator for moving the beam of light and the detector relative to each other such that the detector averages the intensity of the light beam over time. In another embodiment, the laser source is a laser diode. In another embodiment, the translator comprises a corner cube reflector having a moving reflective wall into which is passed the beam of light. In yet another embodiment, the translator comprises a rotating transparent polygon through which is passed the beam of light. In another embodiment the translator comprises a translator physically moving the light source relative to the detector.

Another aspect the invention relates to an apparatus for moving a beam of light in a direction perpendicular to its direction of propagation. In one embodiment the apparatus includes a first reflective surface; a second reflective surface oriented orthogonal to the first reflective surface; and a translator moving the first and second reflective surfaces relative to each other. In another embodiment the translator is a piezoelectric transducer driven by a waveform generator. In yet another embodiment the translator is a speaker cone driven by a waveform generator. In still yet another embodiment the speaker cone is a subwoofer.

Systems and methods of the invention are especially useful in nucleic acid sequencing reactions and especially in single molecule sequencing as disclosed, for example, in U.S. Pat. No. 7,282,337, incorporated herein by reference.

In another embodiment, a system for increasing the detected spatial uniformity of a diode laser comprises mounting the central axis of a retroreflector eccentric to a mechanical axis of rotation. As the retroreflector is rotated about the mechanical axis, an incoming beam of light is swept through a circle of twice the radius of the eccentricity. The same effect as described above is obtained as high-frequency illumination of the exit beam is reduced in favor of spatially uniform frequencies.

In another embodiment, set screws are used to balance the retroreflector such that vibration is reduced or eliminated. This also contributes to beam uniformity. An exemplary device is shown in FIGS. 9-11.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a diagram of a light ray being reflected by two dimensional depiction of a two-dimensional retroreflector;

FIGS. 2(a, b) are two dimensional depictions of a light ray entering a two-dimensional retroreflector with the reflective surface at various positions;

FIGS. 3(a, b) are two dimensional depictions of a light beam comprising many rays entering a two-dimensional retroreflector with the reflective surface at various positions;

FIG. 4a is a plot of the intensity of light across the detector face as seen by a detector viewing a diode source;

FIG. 4b is a plot of the intensity of light across the detector face as seen by a detector viewing a diode source as averaged by an embodiment of the invention;

FIG. 5 is a two-dimensional depiction of two light rays entering a transparent polygon at normal (90 degree) incidence;

FIG. 6 is a two-dimensional depiction of two light rays entering a transparent polygon at an angle of incidence other than 90 degrees;

FIG. 6a is an enlargement of a portion of FIG. 6; and

FIG. 7(a, b) is a two-dimensional depiction of a light beam comprising many rays entering a transparent polygon, at an angle of incidence other than 90 degrees.

FIG. 8 is an exemplary rotational uniformer as described in paragraph 12 above.

FIG. 9 is a view of a rotary uniformer with set screws for balancing and vibration reduction.

FIG. 10 is an internal view of the rotary uniformer shown in FIG. 8

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

In general, the solution to the problem of spatial non-uniformity in the detected intensity of the light beam from a laser is to move the light beam, which typically is larger than the detector, and the detector relative to each other such that the detector “sees” the spatial variations in the intensity of the beam as it crosses the detector and averages them. One way to produce such relative movement is by use of a retroreflector.

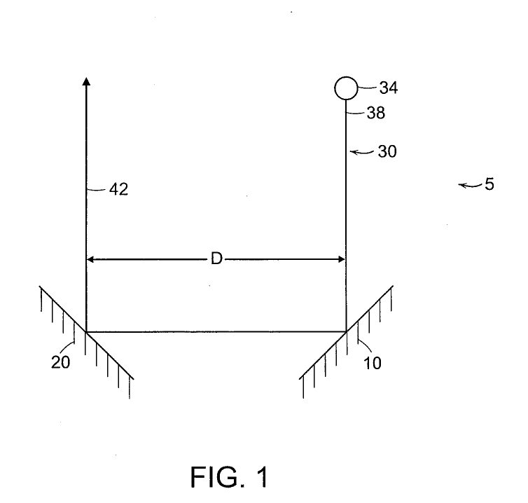

Retroreflectors, usually consisting of three mutually perpendicular intersecting flat reflecting surfaces, return a reflected incident light beam in the direction of its point of origin. An example of a two dimensional retroreflector, in the form of a corner cube reflector 5, is shown in FIG. 1. The corner cube reflector 5 includes two reflective surfaces 10 and 20 oriented 90 degrees to each other. A light ray 30, from a source 34, incident at 45 degrees with respect to the first reflective surface 10 is reflected toward the second reflective surface 20. This second reflecting surface 20 reflects the light ray 30 back in the direction of the source 34. The reflected portion 42 of the light ray 30 is reflected parallel to the incident portion 38 of the light ray 30. The distance (D) between the incident portion 38 of the light ray 30 and the reflected portion 43 is determined by the distance between the reflecting surfaces 10, 20.

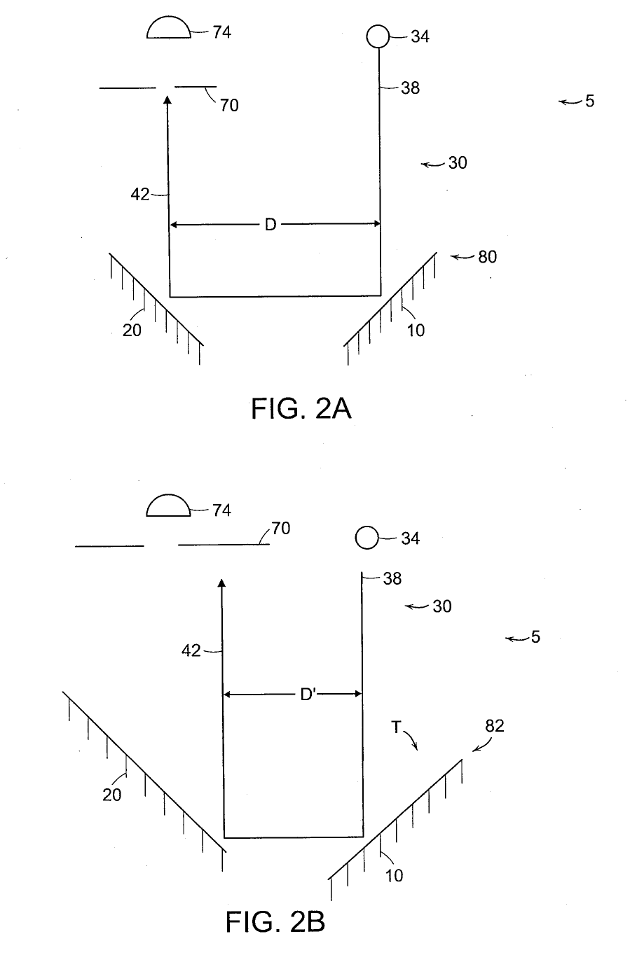

Referring to FIG. 2a, by adjusting the positions of the reflective surfaces 10, 20 relative to each other, the outgoing ray 43 may be translated, such that the distance (D) between the incident portion 38 and the outgoing portion 42 of the light ray 30 varies. In one embodiment of the invention, the first reflective surface 10 is movable, in a direction perpendicular to the reflective surface 10. By moving the first reflective surface 10 while maintaining its orientation with respect to the second reflective surface 20 the distance (D) between the incident portion 38 of the ray and the outgoing 42 portion of the light ray 30 may be altered.

Thus, as the first reflective surface 10 moves, the outgoing portion 42 of the ray 30 translates across an aperture 70 located in the path of the outgoing portion 42 of the ray 30. This change in displacement of the outgoing portion of 42 of the ray 30 determines whether the outgoing portion 42 of the ray 30 will be able to pass through the aperture 70 and reach a detector 74.

In more detail, FIG. 2a shows one light ray 30, reflecting off of the first reflective surface 10, then reflecting off of the second reflective surface 20 to produce the outgoing portion 42 of the ray 30, parallel to and reversed 180 degrees with respect to the incident portion 38 of ray 30. At this location 80 of the first reflecting surface 10, the outgoing portion 42 of the ray 30 then travels through an aperture 70 to reach detector 74.

Referring to FIG. 2b, by shifting (arrow T) the location 82 of the first reflective surface 10 the distance (D′) between the incoming portion 38 of the ray 30 and the outgoing ray 42′ changes. This displacement in the outgoing portion 42′ of the ray 30 causes the ray 30 not to go through the aperture 70 and is thus not seen by the detector 74.

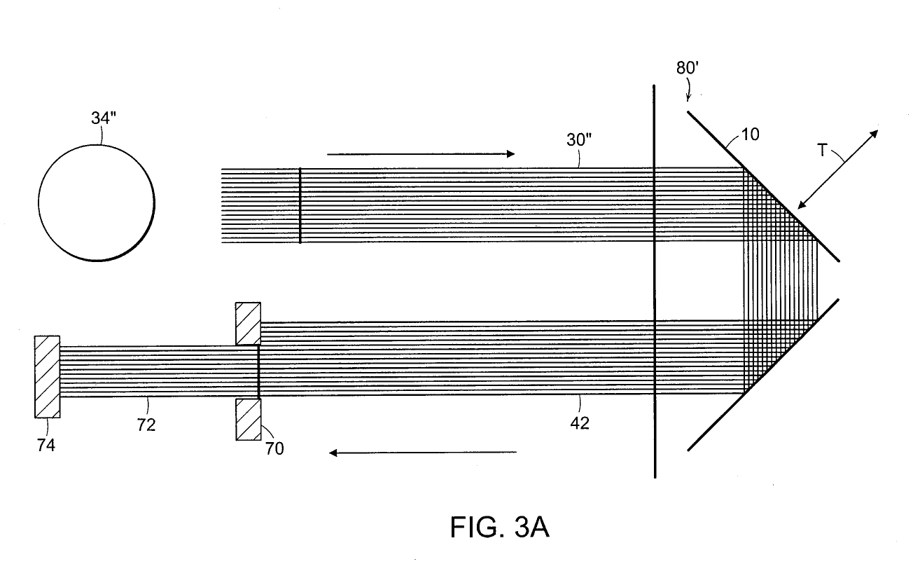

Referring to FIG. 3a, when a beam made up of many rays of light 30′ is considered, for example from an extended source 34′, again at the first location 80′ of the reflective surface 10 multiple light rays will be reflected toward the aperture 70 and only a few 72 will pass through to the detector 74 as in the case of the single ray 30 in FIG. 2a. Referring also to FIG. 3b, as the first reflective surface 10 is moved, (arrow T) those rays 72′ which previously passed through the aperture 70 to reach the detector 74 will not translate across the aperture 70 and no longer reach the detector 74, while some other rays 72′ originally blocked by the aperture 70 will now pass through the aperture 70 and reach the detector 74 again as occurred with the single ray 30 in FIG. 2b.

As the first reflective surface 10 moves back and forth, the different rays that make up the outgoing portion 42 of beam 30 will pass through the aperture 70 and reach the detector 74 at a different point on the detector surface. Thus, although the beam 42 may vary in intensity across its width, the movable reflective surface 10 in conjunction with the aperture 70 creates an averaged resultant image on the detector 74 with greater uniformity of intensity. Every pixel of a multi-pixel detector, will see over time, approximately the same average amount of light as every other pixel if the first reflective surface 10 moves through several cycles over the course of an exposure. Therefore, the retroreflector 5 creates conditions that promote detection of a more uniform light beam when averaged over time.

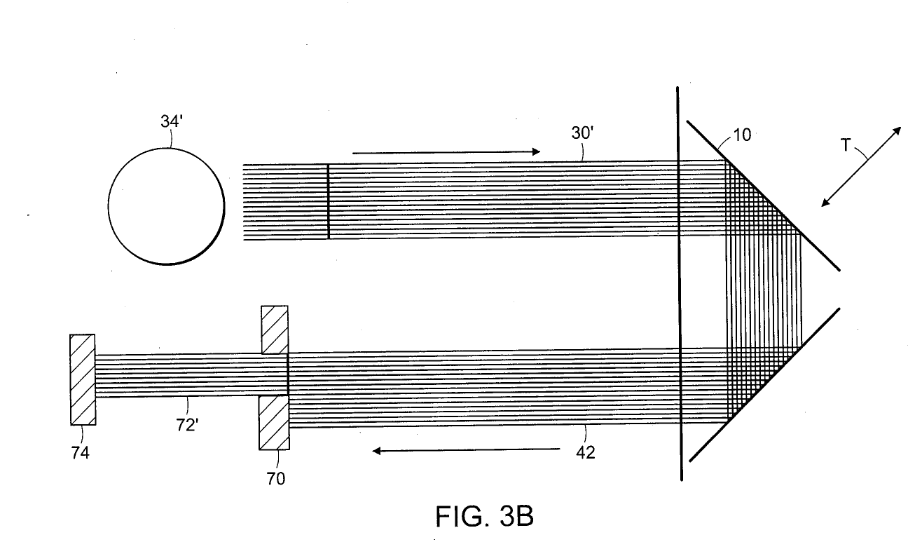

FIG. 4a shows the measured value of the intensity of light as seen across the detector face when the detector is viewing a diode laser source. The peaks in the intensity plot are caused by “hot spots” in the facet of the diode laser. FIG. 4b shows the measured value of the intensity of light as seen across the detector face when the detector is viewing a diode laser source that has been averaged using the invention. The peaks and valleys in the intensity plot, caused by mode structure in the laser, are averaged out as the image is moved across the detector by the movement of the first reflector.

In various embodiments the reflective surfaces 10, 20 are preferably silvered mirrors, but may be composed of any reflective material. Although the invention has been described in terms of moving the first reflective surface 10 in a direction perpendicular to the surface, in another embodiment, the second reflective surface 20 is movable. In another embodiment, both reflective surfaces are movable in opposite directions at the same time.

The reflective surfaces may be translated by any reciprocating means, such that the orientation of the reflective surfaces relative to the beam and each other remains constant. Additionally, in order to make the beam uniform in across both dimensions of the surface of the detector, the first reflective surface 10 may be rotated so a normal to the surface points in a direction that is at 45 degrees to both axes of the incident beam and moves at a 45 degree angle to both the incident beam and the beam reflected to the second surface reflector.

The reflective surface can be driven by any reciprocating means; for example a motor driven cam. In another embodiment, the first reflective surface is mounted to the speaker cone of a subwoofer. In other embodiments the reflective surface is moved using a piezoelectric transducer. In one embodiment the subwoofer or piezoelectric transducer is driven by a sinusoidal wave. In other embodiments, the reflective surface is driven by other types of waves. In another embodiment, the second reflective surface is driven by a second subwoofer. In still another embodiment, both reflective surfaces are driven by respective subwoofers.

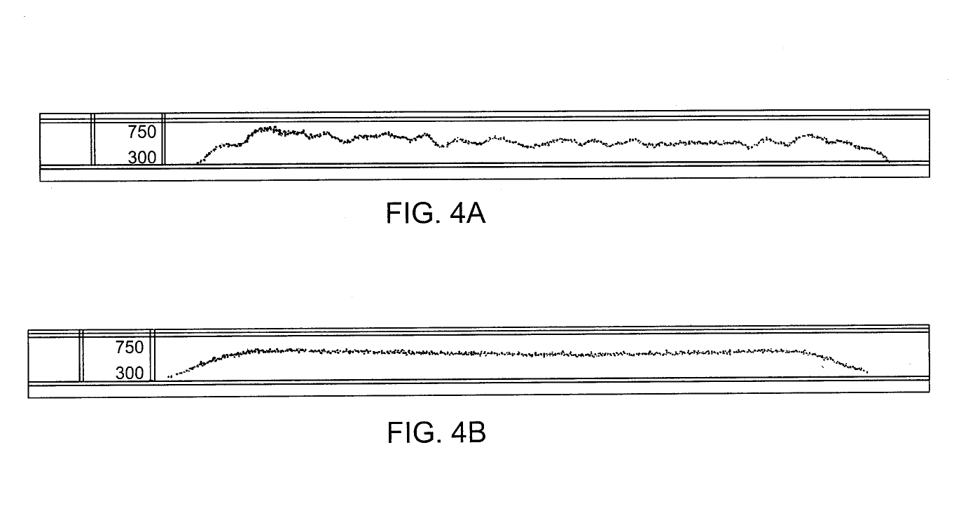

In another embodiment, a rotating polygon may be used to create a beam of uniform intensity from a laser beam. As shown in FIG. 5, two incident light rays 80, 84 enter the polygon 90, perpendicular to the surface 92 of the polygon 90. Using one incident ray 80 as an example; the incident ray 80 is at normal incidence (90 degrees) to the air/polygon interface 92, and thereby results in the transmitted ray 96 being also perpendicular to that interface 92. When the transmitted ray 96, now the incident ray at the polygon/air interface 100 exits the polygon 90, the incident ray 96 and transmitted ray 104 are both perpendicular to the interface 100. Therefore, the ray 80 incident to the polygon 90 and the ray 104 transmitted out through the polygon 90 have the same orientation, i.e., they are both perpendicular to the surface of the polygon. Thus, at normal incidence, an incoming ray passes straight through the polygon. The same process affects the other incident ray 92 depicted in FIG. 5.

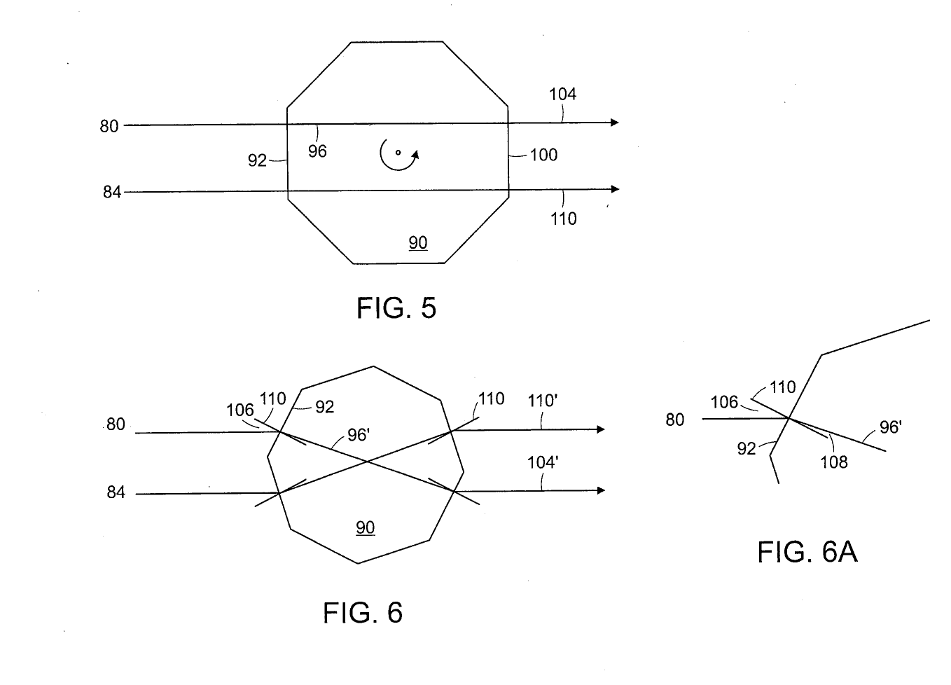

Referring to FIG. 6, as the polygon 90 is rotated, the angle of incidence 106 to the air-polygon interface 92 changes, thus changing the angle of refraction 108 inside the polygon 90. (FIG. 6a is an enlargement to clearly show these angles.) For example, incident ray 80 meets the interface 92 of the polygon at an angle 106 that is not normal to the polygon surface 92 and #, the beam 96′ within the polygon 90 is refracted toward the normal 110 of the interface 92 at an angle 108 as dictated by Snell's Law. The ray 96′ passes through the polygon 90 and becomes the incident ray at the polygon-air interface 110. Because the light is passing from the material into air the incident ray 96′ is refracted away from the normal to the surface resulting in the transmitted ray 104′. The same process affects the other incident ray 84 depicted in FIG. 6. As the polygon 90 is rotated, the beams are deflected less and eventually when the interface 92 is again perpendicular to the beam the light passes through the polygon as described above with regard to FIG. 5. The result is such that the transmitted rays 104 and 110 walk across each other as the polygon is rotated.

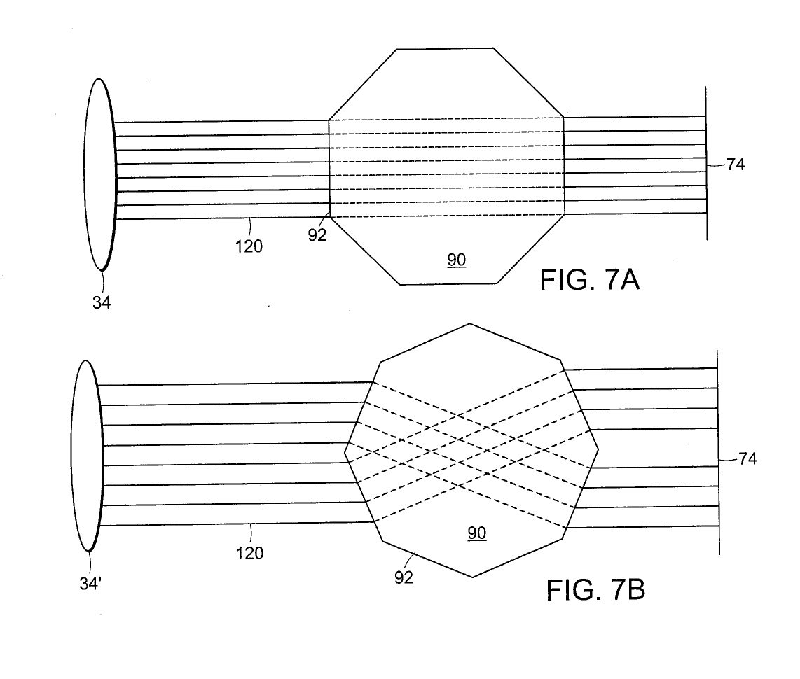

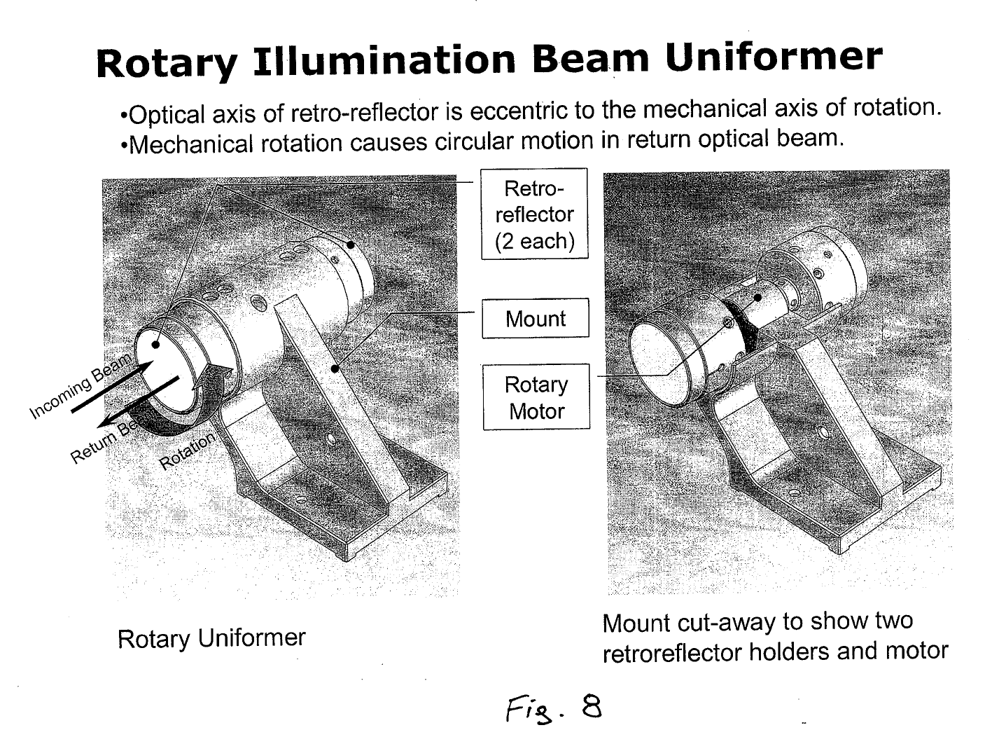

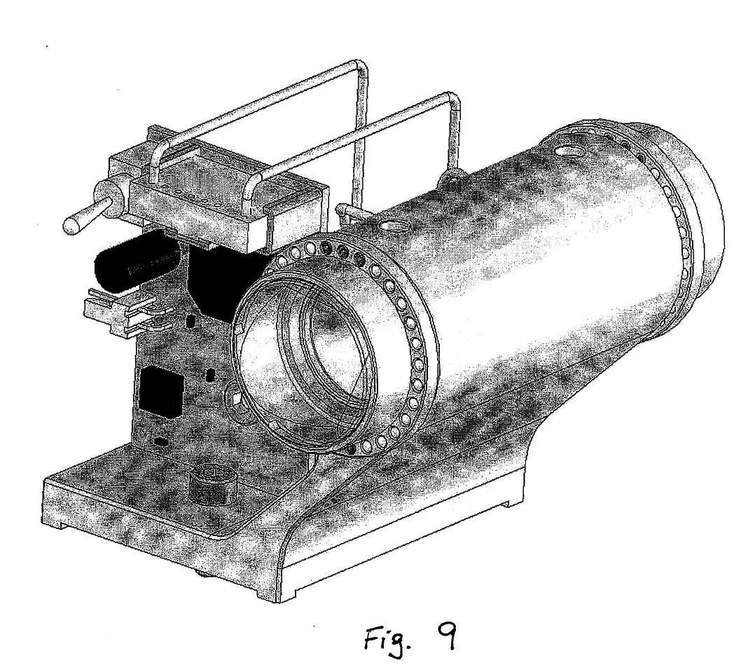

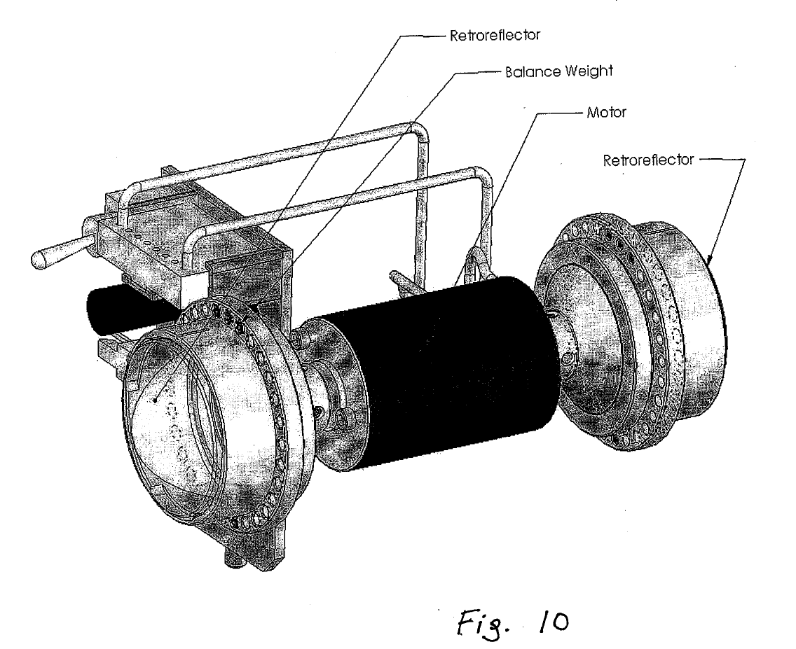

Referring to FIG. 7a, when a beam 120 made up of many rays of light is considered, for example from an extended source 34, is incident to the surface 92 at an angle of 90°, the beam 80 will pass straight through the polygon 90 to a detector 74. Referring also to 7b, as the polygon 90 is rotated the angle of incidence of the rays with respect to the interface 92 changes, changing the angle of refraction and the point on the opposite surface of the polygon 90, where the beam 128 will exit and reach the detector 74. As the polygon 32′ rotates, the rays of the beam will walk across each other such that each part of the detector 74 will detect substantially the same intensity of light over time. Thus, the rotating polygon 90 provides a way to spatially average the intensity of the beam over the width of the beam 120.

The polygon may be composed of any material able to transmit light rays. In the embodiment shown, the polygon is an octagon, but any polygon can be used. The preferred embodiment uses a glass polygon, with an index of refraction greater than about 1.9. The polygon may be rotated at various speeds to obtain the correct level of uniformity of intensity. In the preferred embodiment the polygon is rotated at a speed about twice the exposure time.

Variations, modification, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method of increasing the detected spatial uniformity of the intensity of a beam of light from a laser in a system including the laser and a light detector, the method comprising the steps of:
generating a beam of light with the laser; and
moving the beam of light and the light detector relative to each other, such that the detector averages the spatial intensity of the beam of light over time.

2. The method of claim 1, wherein the step of moving the beam comprises the step of passing the beam of light into a retroreflector and moving a reflective wall of said retroreflector.

3. The method of claim 1, wherein the retroreflector is a corner cube reflector.

4. The method of claim 1, wherein the step of moving the beam comprises physically moving the light source relative to the detector.

5. The method of claim 1, wherein said detector is exposed to only a portion of the beam at any one time.

6. The method of claim 1, wherein the step of generating the beam of light with a laser comprises generating the beam of light with a diode laser.

7. A system for increasing the detected spatial uniformity of the intensity of a beam of light comprising:
a light detector;
a laser source for generating said beam of light; and
a means for moving the beam of light and the detector relative to each other such that the detector averages the intensity of the light beam over time.

8. The system of claim 7 wherein the means for moving comprises a retroreflector having a moving reflective wall into which is passed the beam of light.

9. The system of claim 7 wherein the means for moving comprises a rotating transparent polygon through which is passed the beam of light.

10. A system for increasing the detected spatial uniformity of the intensity of a beam of light comprising:
a light detector;
a laser source for generating said beam of light; and
a translator moving the beam of light and the detector relative to each other such that the detector averages the intensity of the light beam over time.

11. The system of claim 10 wherein said laser source is a laser diode.

12. The system of claim 10 wherein the translator comprises a retroreflector having a moving reflective wall into which is passed the beam of light.

13. The system of claim 10 wherein the translator comprises a rotating transparent polygon through which is passed the beam of light.

14. The system of claim 10 wherein the translator comprises a translator physically moving the light source relative to the detector.

15. An apparatus for moving a beam of light in a direction perpendicular to its direction of propagation, the translator comprising:
a first reflective surface;
a second reflective surface oriented orthogonal to the first reflective surface; and
a translator moving said first and second reflective surfaces relative to each other.

16. The apparatus of claim 15 wherein said translator is a piezoelectric transducer driven by a waveform generator.

17. The apparatus of claim 15 wherein said translator is a speaker cone driven by a waveform generator.

18. The apparatus of claim 17 wherein said speaker cone is a subwoofer.

19. The method of claim 1, wherein said moving step comprises rotating said retroreflector about a mechanical axis.
